(19) United States
(12) Patent Application Publication
(10) Pub. No.: US 2014/0201177 A1
(43) Pub. Date: Jul. 17, 2014

(54) ACCESSING A FILE SYSTEM USING A HARD LINK MAPPED TO A FILE HANDLE

(71) Applicant: RED HAT, INC., Raleigh, NC (US)

(72) Inventors: Amar Tumballi Suryanarayan, Shimoga (IN); Anand Vishweswaran Avati, Mysore (IN)

(73) Assignee: RED HAT, INC., Raleigh, NC (US)

(21) Appl. No.: 13/740,084

(22) Filed: Jan. 11, 2013

(51) Int. Cl. G06F 17/30

(52) U.S. Cl. CPC G06F 17/30194
USPC 707/705

(57) ABSTRACT

A server computer system receives a request for access to an object in a file system. The object is a file or a directory. The server computer system identifies an object handle in the request. The object handle is an identifier of the object. The server computer system identifies an object link that is associated with the object handle. The object link is a hard link to the file or a relative symbolic link to the directory. The server computer system accesses the object using the object link that is associated with the object handle.

### TECHNICAL FIELD

The present disclosure relates to accessing a file system, and more particularly, to accessing the file system using a hard link mapped to the file system.

### BACKGROUND

Data may be stored in a structured data format, such as in a database, and/or data may be stored as unstructured data, for example, in files and folders in a digital file system. Some file systems may be a distributed file system and may have a disk-based data storage in the backend. Typically, a disk-based file system has an architecture where the storage layer that performs the operations for storing and retrieving the data uses file names and directory names on the disk-based backend. The distributed file system can access data, which is a file or a directory, by using a path (e.g., file path) to the data on the disk-based backend.

Some file systems may be implemented in the kernel space and some file systems may be implemented in a user space. Generally, file systems that are implemented in the user space may be restricted to perform file access operations on files in the file system using the file name and the file path. When a file is created in a file system, some file systems generate a file handle for the file. A file handle is a file identifier that is independent of the file name and can be used to access the file. Clients, such as, file system clients, can store the file handle and can use the file handle for subsequent requests to access a file. Typically, the file handle is associated with the file's initial directory location and a file's initial file name. Over time, the file may be renamed or moved to a different directory. The client may receive an error when the client attempts to use the file handle associated with the name of a file that has been moved or renamed. Some solutions for user-space implemented file systems may use a database to map file handles to a new file name and/or a new directory for the file. The database may store the file handle and the corresponding current path based on the file name. When the file is renamed, the database may be updated to reflect the new file name and/or new path. When a client uses the file handle to request access to a file, some file systems can use the database to get the latest file name and/or path of the file and may access the file using the latest file name and/or path. In general, maintaining such a database is an expensive solution.

### BRIEF DESCRIPTION OF THE DRAWINGS

The present disclosure will be understood more fully from the detailed description given below and from the accompanying drawings of various implementations of the disclosure.

FIG. 1 illustrates an example system architecture, in accordance with various implementations.

FIG. 2 is a block diagram of an implementation of a data access module.

FIG. 3 is a flow diagram illustrating an implementation for a method for creating a hard link for a file based on a file handle for the file.

FIG. 4 is a flow diagram illustrating an implementation for a method for accessing a file by constructing a path for a hard link from a file handle for the file.

FIG. 5 is a flow diagram illustrating an implementation for a method for creating a relative symbolic link for a directory based on a directory handle for the directory.

FIG. 6 is a flow diagram illustrating an implementation for a method for accessing a directory by constructing a path for a relative symbolic link from a directory handle for the directory.

FIG. 7 is a block diagram of an example computer system that may perform one or more of the operations described herein.

### DETAILED DESCRIPTION

Described herein are a method and system for accessing a file system using an object link mapped to an object handle, according to various implementations. An object can be a file or a directory. An object handle can be a file handle or a directory handle. An object link can be a hard link or a symbolic link. A hard link is a directory entry that points to a location of a file in a file system. Similar to file names, multiple hard links can be created for the same file. If the file is opened using one of its hard links, and changes are made to the file's content, then the changes can also be visible when the file is opened by an alternative hard link or the file name of the file. The hard link can point to the actual data for the file that is stored in the data store. A hard link can be created by a file system or provided by a user. A symbolic link points to a directory and contains a reference to the directory in the form of an absolute or relative path. A symbolic link can be created by a file system or provided by a user.

The file system can use a structure called a file handle to uniquely identify files and a directory handle to uniquely identify directories. The file handle for a file can be a unique identifier for the file that is independent from a user visible file name for the file. The directory handle for a directory can be a unique identifier for the directory that is independent from a user visible name for the directory. The word “unique” can mean “practically unique,” “situationally unique,” or “contextually unique.”

The file system can include one or more hidden directories that are not visible to a user. The hidden directories can include one or more sub-directories and files that are hidden from a user. The file system can store system-created hard links and system-created symbolic links in a hidden directory, and store user-provided file names and directory names, and user-provided hard links and symbolic links in a directory not hidden from a user.

For example, the file system may store a file with the user visible file name “scarymovie” in a user visible directory “honor”. The file “scarymovie” may be assigned a file handle “0550e8400-e29b-41d4-a716-446655440000”. The user visible directory “horror” may be assigned a file handle “067e6162-3b6f-4ae2-a171-2470b63dff00”. A file system client may be a NFS (network file system) client that uses a persistent handle (e.g., file handle, directory handle) when requesting access to a file or a directory. Conventionally, file systems map file handles to file names to locate files, store the mappings in a database, and update the mappings when files are renamed. Implementations of the present disclosure can provide a less costly solution for user-space implemented disk-based file systems to locate files by mapping file handles to hard links.

For example, a storage server in the file system can create a file and a user visible file name for the file. For example, the file may be named “scarymovie”. At the time the file “scarymovie” is created, the server can create the file handle based on the UUID (universally unique identifier) standard. For example, the file handle may be a UUID of “550e8400-e29b-41d4-a716-446655440000” for the file. At the time the file handle is created, the server can create a hard link for the file based on the file handle. For example, if the file handle is “550e8400-e29b-41d4-a716-446655440000” for the file “scarymovie”, the server can use “550e8400-e29b-41d4-a716-446655440000” as the name of the hard link. The server can store the hard link in a hidden directory in the file system. For example, the hidden directory may be named “.hiddenfs”.

In one implementation, the server stores the hard link in a sub-directory in the hidden directory. In one implementation, the sub-directory is a second level sub-directory that is within a first level sub-directory. The server can name the sub-directories based on at least a portion of the file handle. A portion can be a subset of hexadecimal symbols in the file handle. Hexadecimal symbols can include, for example, 0-9, A-F, and a-f. For example, the server can use the file handle as the name of the hard link. For example, for the file handle “550e8400-e29b-41d4-a716-446655440000” for “scarymovie”, the server can name a first level sub-directory as “55” and a second level sub-directory in the first level sub-directory as “0e”, which correspond to the first two subsets of two hexadecimal symbols in the file handle. The server may store the hard link “550e8400-e29b-41d4-a716-446655440000” such that the hard link has a path of “.hiddenfs/55/0e/550e8400-e29b-41d4-a716-446655440000”.

A NFS client may request access to a file “scarymovie” using the file handle “550e8400-e29b-41d4-a716-446655440000”. Implementations receive the request and construct the path for a hard link based on the file handle “550e8400-e29b-41d4-a716-446655440000”. The path that is constructed can include the name of a hidden directory that stores the hard link, one or more sub-directories in the hidden directory, and the file handle for the file for the file. The names of the sub-directories can correspond to the symbols in the file handle. For example, the constructed path may be “.hiddenfs/55/0e/550e8400-e29b-41d4-a716-446655440000”. Implementations can perform an open operation using the path of the hard link (e.g., “.hiddenfs/55/0e/550e8400-e29b-41d4-a716-446655440000”) to access the requested file data. Even if the user visible file name “scarymovie” is renamed, the path “.hiddenfs/55/0e/550e8400-e29b-41d4-a716-446655440000” for the hard link can still point to the data for the file.

In another example, the storage server can create a directory in the file system. For example, the directory may be named “2010”. The directory “2010” may have a parent directory “movies”. The directory “2010” may have a sub-directory “horror”. The “horror” sub-directory may store the file “scarymovie”. For example, the directory hierarchy related to the “scarymovie” file may be “/movies/2010/horror/scarymovie.” At the time the directory and sub-directories are created, the server can create directory handles for the directory and sub-directories. For example, the directory handle for the directory “movies” may be “0712a57a-c493-4c6f-a0e9-8fe26a524f23”, the directory handle for the directory “2010” may be“f81d4fae-7dec-11d0-a765-00a0c91e6bf6”, and the directory handle for the directory “horror” may be “067e6162-3b6f-4ae2-a171-2470b63dff00”. At the time the directory handles are created, the server can create relative symbolic links for the given directory and sub-directories based on the directory handles for their respective parent directories. In one implementation, the relative symbolic link that is created for a given directory (e.g., “2010”) does not point directly to the location of the given directory (e.g., “2010”), but points to another relative symbolic link, that of the parent directory (e.g., “movies”) of the given directory (e.g., “2010”). If a parent directory (e.g., “movies”) is renamed, the server can create a new relative symbolic link for the parent directory (e.g., “movies”) that points to the newly named directory. But, the relative symbolic link for the sub-directory (e.g., “2010”) is still valid because the relative symbolic link for “2010” is a pointer that points to the relative symbolic link for “movies” which is a pointer to the newly named directory.

The relative symbolic link that is created for a given directory (e.g., “2010”) can include a pointer to the relative symbolic link for the parent directory (e.g., “movies”), which points to the location of the parent directory (e.g., “movies”). The relative symbolic link can have the given directory name (e.g., “2010”) appended to the location of the parent directory to be used for locating the given directory (e.g., “2010”) based on the location of the parent directory (e.g., “movies”). The relative symbolic links can be “resolved” to determine what they point to. “Resolving” a relative symbolic link can refer to determining what the symbolic link is pointing to until a final location is reached, for example, until no other relative symbolic links are encountered. In one implementation, the final destination reached by the server is the parent directory. A given user visible directory can be accessed relative to the location of the parent directory. For example, the server can locate the given directory “2010” based on the location of the parent directory “movies”.

The server can store the relative symbolic links in the hidden directory in the file system. In one implementation, the server stores the relative symbolic links in a sub-directory in the hidden directory. In one implementation, the sub-directory is a second level sub-directory that is within a first level sub-directory. The server can name the sub-directories based on at least a portion of the directory handles. A portion can be a subset of hexadecimal symbols in the file handle. For example, the relative symbolic link for the directory “2010” may be stored at “.hiddenfs/f8/1d/f81d4fae-7dec-11d0-a765-00a0c91e6bf6”.

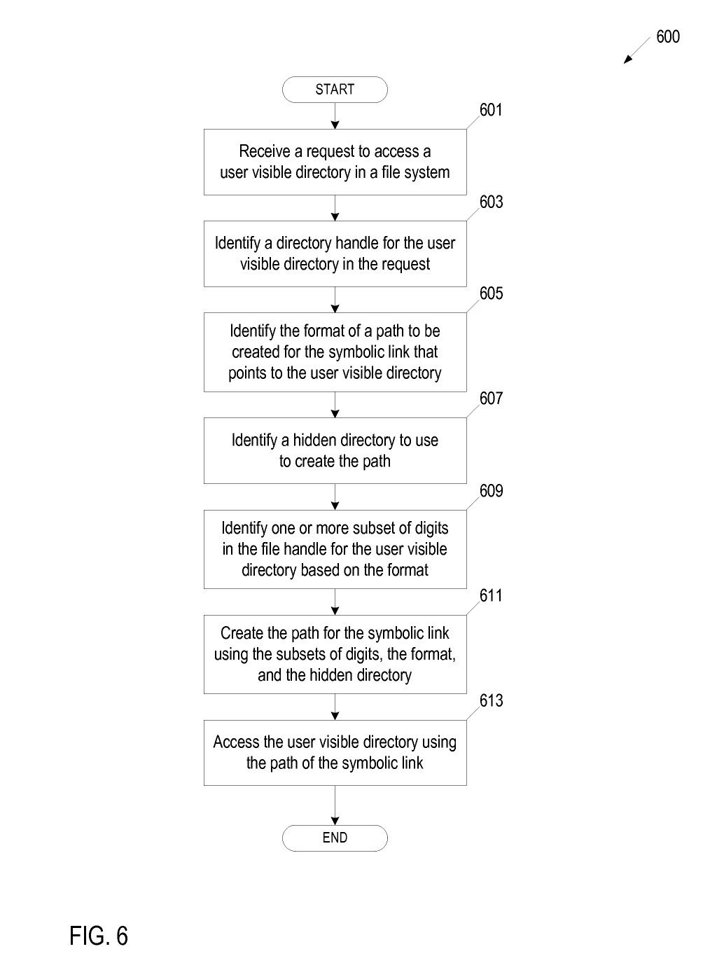

A NFS client may request access to a directory “2010” using the directory handle “f81d4fae-7dec-11d0-a765-00a0c91e6bf6”. Implementations receive the request and construct the path for the relative symbolic link that is in the hidden directory based on the directory handle. The path that is constructed can include the name of a hidden directory that stores the relative symbolic link, one or more sub-directories in the hidden directory, and the directory handle for the directory. The names of the sub-directories can correspond to the symbols in the file handle. For example, the directory “2010” may have a directory handle of “f81d4fae-7dec-11d0-a765-00a0c91e6bf6”. The path for the relative symbolic link that is constructed from the file handle may be “.hiddenfs/f8/1d/f81d4fae-7dec-11d0-a765-00a0c91e6bf6”. Implementations can perform an open operation using the path of the relative symbolic link (e.g., “.hiddenfs/f8/1d/f81d4fae-7dec-11d0-a765-00a0c91e6bf6”) to access the requested directory (e.g., “2010”). Even if a parent directory name is changed for the requested directory, the relative symbolic link can still point to the requested directory. For example, if the parent directory is “movies” for “2010” and is renamed to “HDmovies”, the relative symbolic link for the directory “2010” can still point to the location of “2010”. One implementation describing accessing a directory using a relative symbolic link that is based on the directory handle even when a parent directory is renamed is described in greater detail below in conjunction with FIG. 6.

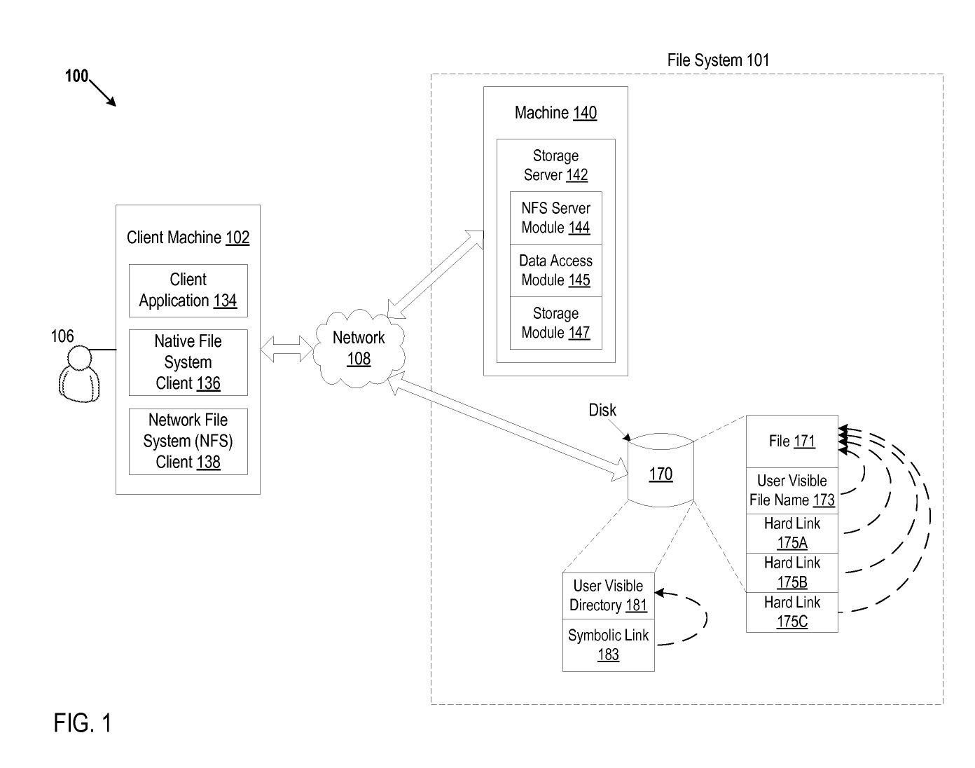

FIG. 1 is an example system architecture 100 for various implementations. The system architecture 100 can include a distributed file system 101 coupled to one or more client machines 102 via a network 108. The network 108 may be a public network, a private network, or a combination thereof. The distributed file system 101 can be a network attached storage file system that includes one or more machines 140 and one or more mass storage devices, such as magnetic or optical storage based disks 170, solid-state drives (SSDs) or hard drives, coupled to the machines 140 via the network 108.

The distributed file system 101 can store data as files 171 on storage devices (e.g., disks 170) and can include directories, which are virtual containers within the file system 101, in which groups of computer files 171 and possibly other directories can be kept and organized. Files 171 that are related can be stored in the same directory. A sub-directory is a directory contained inside another directory. A sub-directory can include a sub-directory inside another sub-directory. The top-most directory is referred to as a root directory or top-level directory within the file system 101. Together, the directories form a hierarchy, or tree structure of one or more levels in the file system 101.

The files 171 can have user visible file names 173 that point to the actual location of the stored files in the storage device (e.g., disk 170). The user visible file names 173 can be based, for example, on user input received from a user 106 via the client application 134 and/or a file system client (e.g., native file system client 136, NFS (network file system) client 138). The file system 101 can include user visible directories 181 and hidden directories. The files 171 can be stored in the user visible directories 181. For example, a user 106 may request the file system 101 to create a file 171 with the user visible file name 173 “scarymovie” and to be stored in a user visible directory 181 “honor”.

A machine 140 can include a storage server 142 to manage access to the files 171 that are stored in the file system 101. One or more client machines 102 can include a file system client to communicate with the storage servers 142 in the file system 101. Examples of file system clients can include, and are not limited to, native file system clients 136 and NFS clients 138. “Native” can describe support for specific operating systems. For example, a native file system client 136 may be, and is not limited to, a file system client that supports the Linux operating system. The storage server 142 can include a storage module 147 to handle requests from the native file system clients 136 to access the files 171. A storage server 142 can include a NFS server module 144 to handle requests from NFS clients 138 to access the files 171.

The machines 140 can include, and are not limited to, any data processing device, such as a desktop computer, a laptop computer, a mainframe computer, a personal digital assistant, a server computer, a handheld device or any other device configured to process data. The client machine 102 may a computing device such as a server computer, a desktop computer, a set-top box, a gaming console, a television, a portable computing device such as, and not limited to, mobile telephones, personal digital assistants (PDAs), portable media players, netbooks, laptop computers, an electronic book reader and the like.

A file 171 can have one or more hard links 175A-C, which may be directory entries, that point to the actual location of the file 171. Multiple hard links 175A-C can be created for the same file 171. Some hard links (e.g., hard links 175A-B) can be created based on user input from a user 106. In addition, hard links can be created automatically by storage servers 142. Automatically-created hard links can be stored in a hidden directory. The storage servers 142 can include a data access module 145 to create a hard link (e.g., hard link 175C) for a file 171 and can store the hard link 175C in a hidden directory. The hard link 175C in the hidden directory may not be known to a user 106. The data access module 145 can use the hard link 175C in the hidden directory to access the file 171 when a request that contains a file handle for the file is received from a client machine 102. The client machines 102 can host one or more applications 134. An application 134 can be any type of application including, for example, a web application, a desktop application, a browser application, etc. An application 134 may request access (e.g., read, write, etc.) to the files 171 and/or directories 181 in the file system 101 via a file system client (e.g., native file system client 136, NFS client 138).

For example, a NFS client 138 may include a file handle for a file in a request and send the request to the NFS server 144, which can forward the file handle to the data access module 145. The data access module 145 can receive the request and can use the file handle for the file in the request to construct a path to the hard link 175C in the hidden directory. The data access module 145 can locate the file 171 using the hard link 175C and perform an operation, such as an open operation, on the file 171.

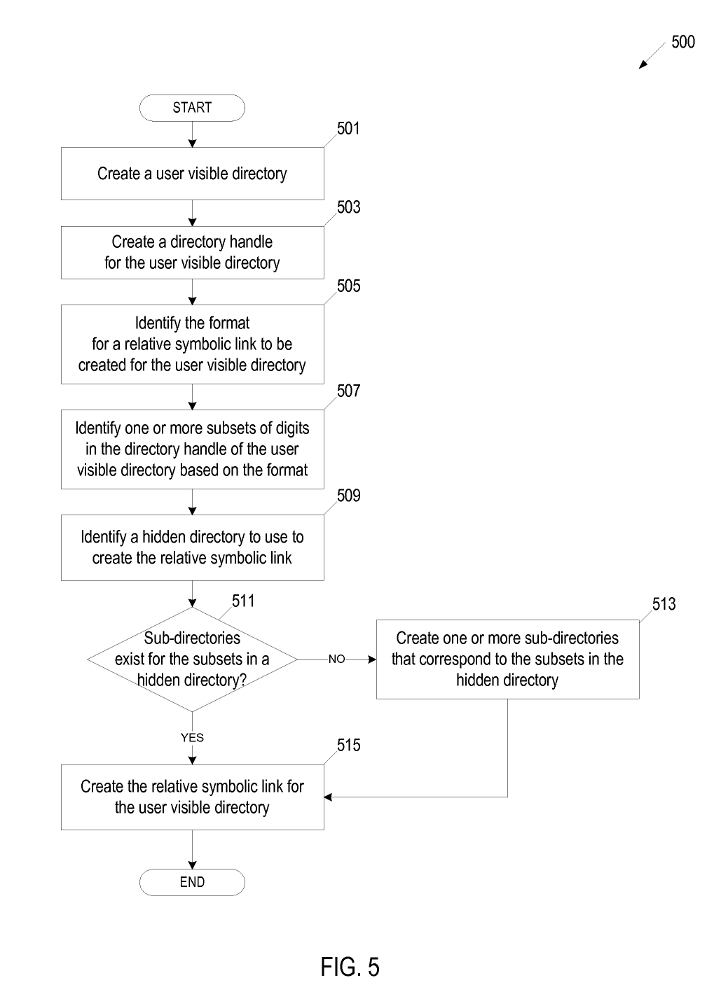

The data access module 145 can create a symbolic link 183 for a given directory 181. The symbolic link 183 can point to a relative symbolic link of the parent directory of the given directory 181. The data access module 145 can create the symbolic link 183 based on the directory handle for the user visible directory 181. The data access module 145 can store the symbolic link 183 in the hidden directory. The symbolic link 183 in the hidden directory may not be known to a user 106. The data access module 145 can use the symbolic link 183 in the hidden directory to access the user visible directory 181 when a request that contains the directory handle for the user visible directory 181 is received from a client machine 102. Implementations of creating and using a symbolic link based on a directory handle for the user visible directory are described in greater detail below in conjunction with FIG. 5 and FIG. 6.

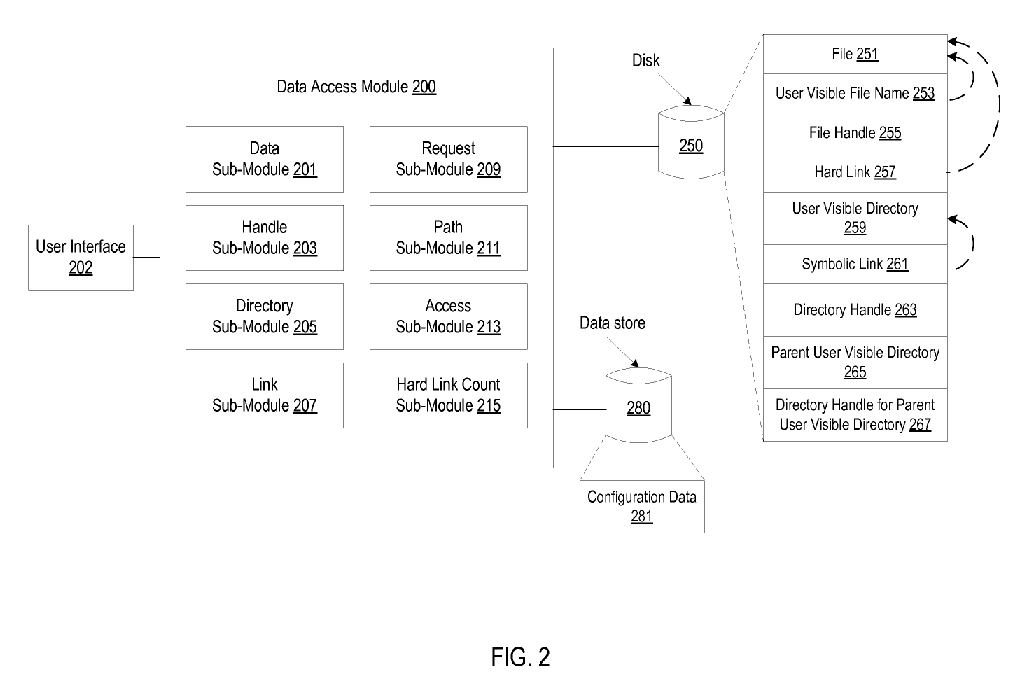

FIG. 2 illustrates a block diagram of one implementation of a data access module 200. The data access module 200 may correspond to a data access module 145 in a server 142) machine 140 of FIG. 1. The data access module 200 can include a data sub-module 201, a handle sub-module 203, a directory sub-module 205, a link sub-module 207, a request sub-module 209, a path sub-module 211, an access sub-module 213, and a hard link count sub-module 215. Note that in alternative implementations, the functionality of one or more of the sub-modules can be combined or divided.

The directory sub-module 205 can create a user visible directory 259 on disk 250. The name of the user visible directory 259 can be based on input received from a user, for example, via a user interface 202 that is coupled to the data access module 200. The user interface (UI) 202 can be a command-line interface, a graphical user interface (GUI), etc. For example, a user may name the user visible directory “honor”.

The data sub-module 201 can create a file 251 and a user visible file name 253 for the file 251 and can store the file 251 and the user visible file name 253 on disk 250. The user visible file name 253 can be based on input received from a user, for example, via the UI 202. The user visible file name 253 can point to the location of the file 251. For example, a user may name the file 251 “scarymovie”. The file 251 may be stored in the user visible directory 259 “horror”.

At the time the user visible directory 259 is created, the handle sub-module 203 can create a directory handle 263 for the user visible directory 259. The directory handle 263 for the user visible directory 259 can be a unique identifier that is independent from the name (e.g., horror) of the user visible directory 259. At the time the file 251 is created, the handle sub-module 203 can create a file handle 255 for the file 251. The file handle 255 for the file 251 can be a unique identifier that is independent from the user visible file name 253 of the file 251. In one implementation, the handles (e.g., file handles 255, directory handles 263,267) are based on the UUID (universally unique identifier) standard. A UUID is a 16-octet (128-bit) number. A UUID has a standard form that is represented by 32 hexadecimal symbols, displayed in five groups separated by hyphens, in the form 8-4-4-4-12 for a total of 36 characters (32 symbols and four hyphens). For example, the handle sub-module 203 may create the file handle 255 for the file 251 “scarymovie” as a UUID of “550e8400-e29b-41d4-a716-446655440000”, which is independent from the user visible filename 253 “scarymovie”. In another example, the handle sub-module 203 may create the directory handle 263 for the user visible directory “horror” as a UUID of “067e6162-3b6f-4ae2-a171-2470b63dff00”, which is independent from the name of the user visible directory 259 “honor”. The handle sub-module 203 can store the handles (e.g., file handles 255, directory handles 263,267) in the file system, for example, on disk 250 or on a data store 280 that is coupled to the handle sub-module 203.

The directory sub-module 205 may have created a parent user visible directory 265 based on user input. At the time the parent user visible directory 265 is created, the handle sub-module 203 can create a directory handle 267 for the parent user visible directory 265. The directory handle 267 for the parent user visible directory 265 can be a unique identifier that is independent from the name of the parent user visible directory 265. For example, directory sub-module 205 may have created a directory “horror” that has a parent directory “2010” that has a parent directory “movies”. The directory “honor” may have a file “scarymovie”. The path for “scarymovie” may be “/movies/2010/horror/scarymovie”. The directory “movies” may have a parent directory that is the root directory.

The data store 280 can be a persistent storage unit. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items.

The directory sub-module 205 can create a hidden directory in the file system. The name of the hidden directory can be based on user input received via the UI 202. For example, a user may name a hidden directory “hiddenfs”. The name of the hidden directory can be stored as part of configuration data 281 that is stored in the data store 280. The directory sub-module 205 can create one or more sub-directories in the hidden directory based on the configuration data 281. The configuration data 281 can specify the format of the sub-directory names that should be used. For example, the configuration data 281 may specify that the format of the sub-directory names should be two hexadecimal symbols. The configuration data 281 can be user-defined data. For example, a system administrator user may provide the user input for the configuration data 281 via the UI 202.

The sub-directory names can correspond to specific files and/or directories. For example, the sub-directory names can include subsets of symbols (e.g., hexadecimal symbols) in the file handles 255 for the files 251 and the directory handles 263 for the user visible directories 259. In one implementation, a subset of symbols includes two symbols. In one implementation, the configuration data 281 specifies that there should be sub-directories that correspond to the first two subsets of symbols in the handles (e.g., file handles 255, directory handles 263,267). For example, the directory sub-module 205 may create a sub-directory named “55” and another sub-directory named “0e” which correspond to the first two subsets of symbols in the file handle 255 “550e8400-e29b-41d4-a716-446655440000” for the file 251 “scarymovie”. In another example, the directory sub-module 205 may create a sub-directory named “06” and another sub-directory named “7e” which correspond to the first two subsets of symbols in the directory handle 263 “067e6162-3b6f-4ae2-a171-2470b63dff00” for the user visible directory 259 “honor”.

When a handle (e.g., file handle 255, directory handle 263,267) is created by the handle sub-module 203, the directory sub-module 205 can examine the hidden directory to check whether there are already sub-directories in the hidden directory that have names that match subsets (e.g., the first two subsets) of symbols of the handles (e.g., file handles 255, directory handles 263,267) that are created. The directory sub-module 205 can create a sub-directory with a name that corresponds to a subset of symbols of the handles (e.g., file handles 255, directory handles 263,267) if a sub-directory with a matching name was not already created.

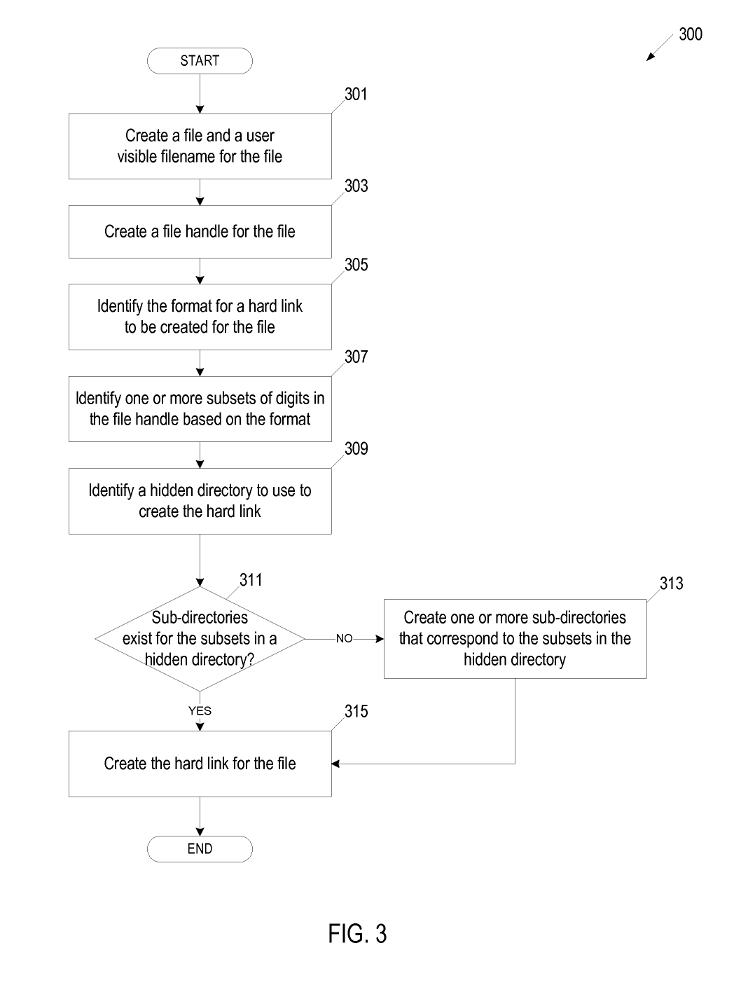

The hidden sub-directories can be used to store hard links 257 for the files 251 and symbolic links 261 for user visible directories 259. The link sub-module 207 can create a hard link 257 for the file 251 and can create a symbolic link 261 for a user visible directory 259. The link sub-module 207 can execute a command to create a hard link 257 for a file 251 and to configure the hard link 257 to point to the location of the file 251. One implementation for creating a hard link for a file is described in greater detail below in conjunction with FIG. 3. The link sub-module 207 can execute a command to create a symbolic link 261 for a user visible directory 259 and to configure the symbolic link 257 to point to a relative symbolic link of the parent directory, which points to the location of the parent directory. The location of the user visible directory 259 can be located relative to the location of the parent directory. One implementation for creating a symbolic link for a user visible directory is described in greater detail below in conjunction with FIG. 5. In one implementation, the link sub-module 207 can determine when a user visible directory 259 is renamed or when the user visible directory 259 is moved to a new location, and can create a new symbolic link 261 to reflect the new name of the user visible directory 259 or the new directory location and delete the old symbolic link.

A sub-directory is chosen for storing a specific hard link/symbolic link based on configuration data 281 that is stored in the data store. For example, the configuration data 281 may specify that the format of the path for the hard link 257 should include the hidden directory, followed by one or more sub-directory names, followed by the file handle for the file. The sub-directory names can correspond to the symbols in the file handle 255 that is in the request. In another example, the configuration data 281 may specify that the format of the path for the symbolic link 261 should include the hidden directory in the file system, followed by one or more sub-directory names, followed by the file handle for the user visible directory. The sub-directory names can correspond to the symbols in the directory handle 263 that is in the request. The formats may include one or more “/” slash delimiters.

The data access module 200 can provide the handles (e.g., file handles 255, directory handles 263,267) to clients, such as file system clients (e.g., NFS clients), which can use the handles (e.g., file handles 255, directory handles 263,267) for requests to access the file 251 and/or user visible directories 259,265. The request sub-module 209 can receive requests from clients (e.g., NFS clients) for access to files 251 and/or user visible directories 259,265. The requests can include the corresponding file handle 255,263,265. When the request sub-module 209 receives a request for access to a file 251, the path sub-module 211 can create a path for the hard link 257 that points to the location of the file 251 using the file handle 255 for the file 251 in the request. When the request sub-module 209 receives a request for access to a user visible directory 259, the path sub-module 211 can create a path for the symbolic link 261, which points to a relative symbolic link of the parent directory of the user visible directory 259, using the directory handle 263 for the user visible directory 259 in the request. The user visible directory can be located based on the location of the parent directory.

The path sub-module 211 can identify the format of the path for the hard link 257 and the format for the path for the symbolic link 261 that should be used from the configuration data 281. The configuration data 281 can specify the number of sub-directories that should be used to create the path for the hard link 257 and the path for the symbolic link 261.

The path sub-module 211 can create the path for the hard link and the path for the symbolic link using subsets of symbols in the file handle that was included in the request and the name of the hidden directory in the configuration data 281. For example, the path sub-module 211 may identify that the first subset is “55” and the second subset is “0e” in the file handle 255 “550e8400-e29b-41d4-a716-446655440000” for a file 251 in a request. The path sub-module 211 may identify the name of the hidden directory is “hiddenfs”. The path sub-module 211 may create a path for the hard link as “.hiddenfs/55/0e/550e8400-e29b-41d4-a716-446655440000.” In another example, the path sub-module 211 may identify that the first subset is “06” and the second subset is “7e” in the directory handle 263 “067e6162-3b6f-4ae2-a171-2470b63dff00” for a user visible directory 259 in a request. The path sub-module 211 may identify the name of the hidden directory is “hiddenfs”. The path sub-module 211 may create a path for the symbolic link as “.hiddenfs/06/7e/067e6162-3b6f-4ae2-a171-2470b63dff00”.

The access sub-module 213 can perform an operation, such as an open operation, on a path for the hard link 257 to access the file 251. The access sub-module 213 can perform an operation, such as an open operation, on a path for the symbolic link 261 to access the user visible directory 259.

A user may wish to know how many hard links a file may have. The server can provide the user created hard links as part of the link count, but may hide the system created hide links. The hard link count sub-module 215 can receive a request for a count for the total number of hard links that are associated with a particular file 251 and can modify the actual hard link count value for the file 251 to return a value which does not reflect the hard link 257 in the hidden directory. The hard link count sub-module 215 can modify the actual hard link value by reducing the actual hard link value by one and provide the modified hard link value in response to a request for the hard link count for a particular file 251.

FIG. 3 is a flow diagram of an implementation of a method 300 for creating a hard link for a file based on a file handle for the file. Method 300 can be performed by processing logic that can comprise hardware (e.g., circuitry, dedicated logic, programmable logic, microcode, etc.), software (e.g., instructions run on a processing device), or a combination thereof. In one implementation, method 300 is performed by a data access module 145 in a server 142 in a machine 140 of FIG. 1.

At block 301, the server creates a file and a user visible file name for the file. For example, the file may be named “scarymovie”. At block 303, the server creates a file handle for the file. For example, the server may create the file handle as a UUID of “550e8400-e29b-41d4-a716-446655440000”, which is independent from the user visible filename “scarymovie”.

The server can create a hard link for the file based on the file handle. In particular, at block 305, the server identifies the format of the hard link that is to be created for the file. The server can access configuration data that is stored in a data store that is coupled to the server to determine the format. For example, the configuration data may specify that the name of the hard link should be the file handle, and that the hard link should be stored in a hidden directory in the file system, and in one or more sub-directories in the hidden directory.

At block 307, the server identifies the hidden directory to use to create the hard link, for example, from the configuration data. The configuration data may store the name of the hidden directory to be used. For example, the configuration data may specify that the name of the hidden directory is “hiddenfs”. At block 309, the server identifies one or more portions (subsets) of symbols (e.g., hexadecimal symbols) in the file handle for the file. The server can identify the subsets based on the configuration data. In one implementation, the configuration data specifies that the hard link should be stored in a second level sub-directory within a first level sub-directory that is within the hidden directory. The configuration may specify that the name of the first level sub-directory corresponds to a first portion of hexadecimal symbols in the file handle and that the name of the second level sub-directory corresponds to a second portion of hexadecimal symbols in the file handle. In one implementation, a portion includes two hexadecimal symbols. For example, the first portion of hexadecimal symbols in the file handle “550e8400-e29b-41d4-a716-446655440000” may be “55”, and the second portion of hexadecimal symbols in the file handle may be “0e”. For example, at block 309, the server may identify that the first subset is “55” and that the second subset is “0e” in the file handle “550e8400-e29b-41d4-a716-446655440000” for the file.

At block 311, the server determines whether there are already sub-directories that correspond to the subsets of symbols (e.g., hexadecimal symbols) in the hidden directory. The server can search the hidden directory for sub-directories that have names that match the subsets of symbols. For example, the server can search for a sub-directory named “55” and a sub-directory named “0e” within the sub-directory named “55” in the hidden directory. If the sub-directories do not exist in the hidden directory, the server can create the sub-directories at block 313. If the sub-directories exist in the hidden directory, the server creates a hard link for the file using the file handle at block 315 and store it in the specified subdirectories. For example, the server may create a hard link named “550e8400-e29b-41d4-a716-446655440000” and may store the hard link in “.hiddenfs/55/0e/”. The server can execute a command to create the hard link and to configure the hard link to point to the location of the file. For example, in Linux, the command may be “link (<path of original file>,<path of hard link>)”. The server can use the file handle as the hard link name of the hard link file.

A user may wish to know how many hard links a file may have. The server can provide the user created hard links as part of the link count, but may hide the system created hard links. In one implementation, when a hard link is created in the hidden directory, and the server receives a request for a count for the hard links for a file, the server modifies the actual hard link count value to return a value which does not reflect the hard link in the hidden directory. The server can modify the actual hard link value by reducing the actual hard link value by one and provide the modified hard link value in response to a request for the hard link count for a file.

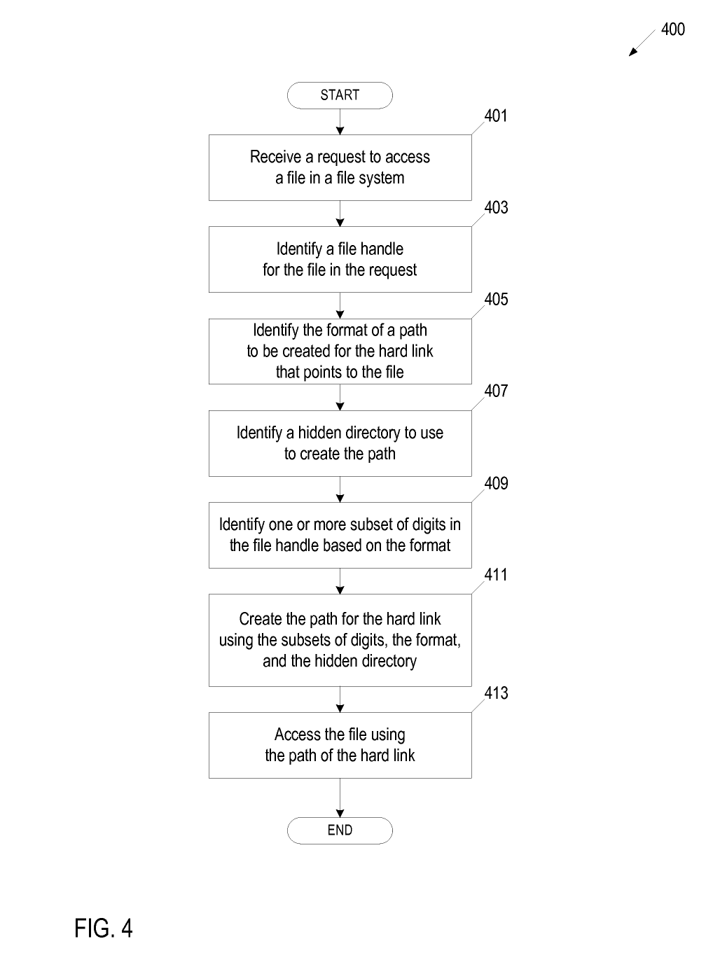

FIG. 4 is a flow diagram of an implementation of a method 400 for locating a file by constructing a path for a hard link from a file handle for the file. Method 400 can be performed by processing logic that can comprise hardware (e.g., circuitry, dedicated logic, programmable logic, microcode, etc.), software (e.g., instructions run on a processing device), or a combination thereof. In one implementation, method 400 is performed by a data access module 145 in a server 142 in a machine 140 of FIG. 1.

At block 401, the server receives a request to access a file in the file system. The request can include a file handle for the file. At block 403, the server identifies the file handle for the file in the request. For example, the file handle in the request may be a UUID that is “550e8400-e29b-41d4-a716-446655440000”.

The server can create a path to a hard link of the file using the file handle. In particular, at block 405, the server identifies the format of the path to be created. The server can access configuration data that is stored in a data store that is coupled to the server to determine the format. For example, the configuration data may specify that the format of the path for the hard link should include a hidden directory, followed by one or more sub-directory names, followed by the file handle. The format can include one or more “/” slash delimiters. In one implementation, the format is “<hidden directory>/<first sub-directory>/<second sub-directory>/<file handle for the file>”. The configuration data can include the number of sub-directories that should be used and the format of the sub-directory names that should be used. For example, the configuration data may specify that the format of the sub-directory names should be two hexadecimal symbols that correspond to the symbols in the file handle.

At block 407, the server identifies the hidden directory that should be used to create the path, for example, from the configuration data. For example, the configuration data may specify that the name of the hidden directory is “hiddenfs”. At block 409, the server identifies one or more subsets of symbols (e.g., hexadecimal symbols) in the file handle for the file in the request. The server can identify the subsets based on the configuration data. For example, the configuration data may specify that the server should identify the first two subsets of hexadecimal symbols in the file handle, where a subset includes two hexadecimal symbols. For example, the server may identify that the first subset is “55” and that the second subset is “0e” in the file handle “550e8400-e29b-41d4-a716-446655440000”.

At block 411, the server creates the path to the hard link of the file using the hidden directory, the one or more subsets of symbols in the file handle, and the file handle. The server can use a dot “.” to denote a hidden directory. For example, the server may create the file path “.hiddenfs/55/0e/550e8400-e29b-41d4-a716-446655440000” for the hard link that points to the requested file. At block 413, the server accesses the hard link using the path created from the handle and locates the file based on the hard link. The server can perform an open operation on the path of the hard link to activate the hard link, which will provide access to the requested file. For example, the server may perform an open operation on the path “.hiddenfs/55/0e/550e8400-e29b-41d4-a716-446655440000” to access the requested file.

FIG. 5 is a flow diagram of an implementation of a method 500 for creating a relative symbolic link for a directory based on a directory handle for the directory. Method 500 can be performed by processing logic that can comprise hardware (e.g., circuitry, dedicated logic, programmable logic, microcode, etc.), software (e.g., instructions run on a processing device), or a combination thereof. In one implementation, method 500 is performed by a data access module 145 in a server 142 in a machine 140 of FIG. 1.

At block 501, the server creates a user visible directory. For example, the user visible directory may be “movies”. At block 503, the server creates a directory handle for the user visible directory. For example, the server may create the directory handle for the user visible directory “movies” as a UUID of “0712a57a-c493-4c6f-a0e9-8fe26a524f23”, which is independent from the user visible directory name “movies”. The server can create a relative symbolic link that points to a relative symbolic link of the parent directory, which points to the location of the parent directory. In the example of “movie”, “movies” may have a parent directory being the root directory.

At block 505, the server identifies the format to use to create the relative symbolic link for the user visible directory. The server can access configuration data that is stored in a data store that is coupled to the server to determine the format. For example, the configuration data may specify that the format of the relative symbolic link may be the name of a hidden directory in the file system, followed by one or more sub-directory names. The format can include one or more “I” slash delimiters. In one implementation, the format is “<hidden directory>/<first level sub-directory>/<second level sub-directory>”. The configuration data can include the number of sub-directories that should be used to create the symbolic link and the format of the sub-directory names that should be used. For example, the configuration data may specify that the format of the sub-directory names should be two hexadecimal symbols and the number of sub-directories should be two.

At block 507, the server identifies a hidden directory to use to create the relative symbolic link, for example, from the configuration data. For example, the configuration data may specify that the name of the hidden directory is “hiddenfs”. At block 509, the server identifies one or more subsets of symbols (e.g., hexadecimal symbols) in the directory handle for the user visible directory based on the configuration data. For example, the configuration data may specify that the server should identify the first two subsets of hexadecimal symbols in the directory handle, where a subset includes two hexadecimal symbols. For example, the server may identify that the first subset is “07” and that the second subset is “12” in the directory handle “0712a57a-c493-4c6f-a0e9-8fe26a524f23” for the user visible directory “movies”.

At block 511, the server determines whether there are already sub-directories that correspond to the subsets of symbols (e.g., hexadecimal symbols) in the hidden directory. The server can search the hidden directory for sub-directories that have names that match the subsets of symbols. For example, the server can search for a sub-directory named “07” and a sub-directory named “12” within the sub-directory named “07” in the hidden directory. If the sub-directories do not exist in the hidden directory, the server can create the sub-directories at block 513. If the sub-directories exist in the hidden directory, the server creates the symbolic link that points to the user visible directory at block 515.

At block 515, the server can execute a command to create the relative symbolic link for user visible directory. The relative symbolic link may be created for the directory “movies” and can point to the relative symbolic link for the parent directory, which is root directory. In one implementation, the root directory is a user assigned export directory for a volume. The server may resolve that the relative symbolic link for the root directory points to the location of root directory and the server can locate “movies” based on the location of the root directory. For example, the sub-directory may be located within the location of the parent directory. The relative symbolic link can include the given directory name (e.g., “movies”) appended to location of the parent directory (e.g., root directory) for the server to be able to locate the given directory (“movies”) within the location of the parent directory (e.g., root directory). The relative symbolic links can be “resolved” to determine what is being pointed to. “Resolving” a relative symbolic link can refer to determining what the symbolic link is pointing to until an actual location is reached, for example, until no other relative symbolic links are encountered. In one implementation, the actual destination reached by the server is the parent directory. A given user visible directory can be accessed relative to the location of the parent directory. In another example, the relative symbolic link may be created for the sub-directory “2010” and can point to the relative symbolic link for the parent directory “movies”. The server may resolve that the relative symbolic link for the parent directory “movies” points to the location of “movies” and the server can locate “2010” within the location of the parent directory “movies”.

At block 515, the server can execute a command to create the relative symbolic link for user visible directory. The command may be “symink(<path of the relative symbolic link of the parent directory with user visible directory name appended to the path of the relative symbolic link of the parent directory>, <path of the symbolic link>)”. For example, the directory “movies” may have the root directory as its parent directory. The path of the relative symbolic link of the root directory may be “ . . . /00/00/00000000-0000-0000-0000-000000000001/”, for example, as defined in configuration data. The configuration data may specify that the path of the symbolic link is <hidden directory>/<first level sub-directory>/<second level sub-directory>/<directory handle>”. The server may determine that the path of the symbolic link for “movies” may be “.hiddenfs/07/12/0712a57a-c493-4c6f-a0e9-8fe26a524f23”. The server may create a relative symbolic link for “movies” by executing the command as “symink( . . . /00/00/00000000-0000-0000-0000-000000000001/movies, .hiddenfs/07/12/0712a57a-c493-4c6f-a0e9-8fe26a524f23)”. When the relative symbolic link for “movies” is created, the relative symbolic link points to the root directory symbolic link, which points to the location of the root directory, and the server can locate the directory “movies” in the location of the root directory.

FIG. 6 is a flow diagram of an implementation of a method 600 for accessing a directory by constructing a path for a symbolic link from a directory handle for the directory. Method 600 can be performed by processing logic that can comprise hardware (e.g., circuitry, dedicated logic, programmable logic, microcode, etc.), software (e.g., instructions run on a processing device), or a combination thereof. In one implementation, method 600 is performed by a data access module 145 in a server 142 in a machine 140 of FIG. 1.

At block 601, the server receives a request to access a user visible directory in the file system. For example, the user visible directory may be “2010”. The request can include a directory handle for the user visible directory. At block 603, the server identifies the directory handle for the user visible directory in the request. For example, the directory handle for the user visible directory “2010” may be “f81d4fae-7dec-11d0-a765-00a0c91e6bf6”. The server can create a path of the relative symbolic link of the directory “2010” that points to the relative symbolic link of its parent directory “movies”. The server can create the path for the relative symbolic link using the directory handle “f81d4fae-7dec-11d0-a765-00a0c91e6bf6” for the user visible directory “2010” from the request. The symbolic link can be stored in a hidden directory in the file system and the server can use the directory handle to construct the path of the symbolic link that is stored in the hidden directory.

At block 605, the server identifies the format to use to create the path for the relative symbolic link. The server can access configuration data that is stored in a data store that is coupled to the server to determine the format. For example, the configuration data may specify that the format of the path for the symbolic link may be “<hidden directory>/<first level sub-directory>/<second level sub-directory>/<directory handle for user visible directory>”.

At block 607, the server identifies the hidden directory to use to create the path for the relative symbolic link. The server can use the configuration data to identify the hidden directory. For example, the configuration data may specify that the name of the hidden directory is “hiddenfs”. At block 609, the server identifies one or more subsets of symbols (e.g., hexadecimal symbols) in the directory handle for the user visible directory. The server can identify the subsets based on the configuration data. For example, the configuration data may specify that the server should identify the first two subsets of hexadecimal symbols in the directory handle, where a subset includes two hexadecimal symbols. For example, the server may identify that the first subset is “f8” and that the second subset is “1d” in the directory handle “f81d4fae-7dec-11d0-a765-00a0c91e6bf6”.

At block 611, the server creates the path for the symbolic link using the hidden directory, the subsets of symbols from the directory handle, and the directory handle. For example, the server may create the path “.hiddenfs/f8/1d/f81d4fae-7dec-11d0-a765-00a0c91e6bf6” as the path for the relative symbolic link. At block 613, the server accesses the user visible directory using the path of the relative symbolic link. For example, the server can resolve the relative symbolic link using the path of the relative symbolic link. For example, the server may resolve that “.hiddenfs/f8/1d/f81d4fae-7dec-11d0-a765-00a0c91e6bf6” does not point directly to the location of the directory “2010” but may point to the location for the parent directory “movies”. At the location for the parent directory “movies”, the server can access the directory “2010” by locating “2010” within the parent directory “movies”.

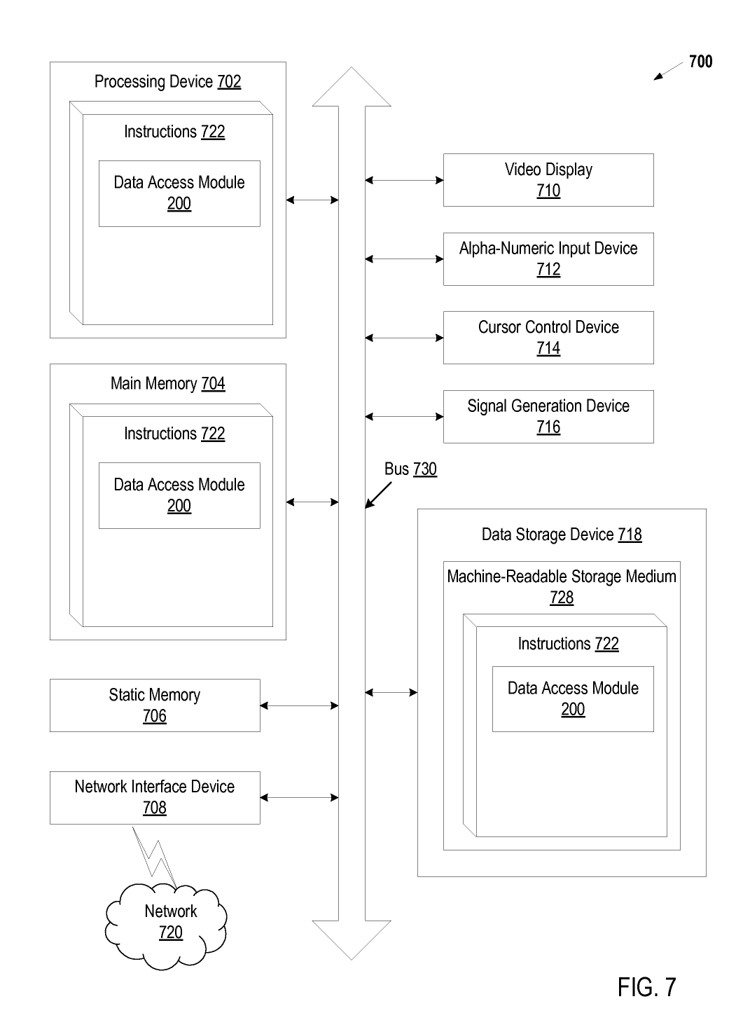

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, or as a peer machine in a peer-to-peer (or distributed) network environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute instructions 722 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-readable storage medium 728 (also known as a computer-readable medium) on which is stored one or more sets of instructions or software 722 embodying any one or more of the methodologies or functions described herein. The instructions 722 may also reside, completely or at least partially, within the main memory 704 and/or within the processing device 702 during execution thereof by the computer system 700, the main memory 704 and the processing device 702 also constituting machine-readable storage media.

In one implementation, the instructions 722 include instructions for a data access module (e.g., data access module 200 of FIG. 2) and/or a software library containing methods that call modules in a data access module. While the machine-readable storage medium 728 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving” or “identifying” or “creating” or “accessing” or “determining” or “providing” or “storing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. A method, comprising:
receiving, by a processing device, a request to access an object in a file system, the request comprising an identifier of the object, wherein the object is a file or a directory;
identifying, in view of the identifier of the object, an object link, wherein the object link is a relative symbolic link to the directory; and
accessing the object using the object link.

2. (canceled)

3. The method of claim 1, wherein the object is the directory and the method further comprises:
creating a directory handle for the directory;
creating the relative symbolic link that corresponds to the directory handle; and
storing the relative symbolic link in a hidden directory in the file system.

4. (canceled)

5. (canceled)

6. The method of claim 1, wherein the object link comprises at least one of a hidden directory in the file system or one or more sub-directories.

7. The method of claim 1, wherein the object is the file and the method further comprises:
receiving a request for a link count for the file; and
providing the link count value.

8. A non-transitory computer-readable storage medium including instructions that, when executed by a processing device, cause the processing device to perform operations comprising:
Receiving, by the processing device, a request to access an object in a file system, the request comprising an identifier of the object, wherein the object is a file or a directory;
Identifying, by the processing device, in view of the identifier of the object, an object link, wherein the object link is a relative symbolic link to the directory; and
Accessing, by the processing device, the object using the object link.

9. (canceled)

10. The non-transitory computer-readable storage medium of claim 8, wherein the object is the directory and the set of operations further comprise:
creating a directory handle for the directory;
creating the relative symbolic link that corresponds to the directory handle; and
storing the relative symbolic link in a hidden directory in the file system.

11. (canceled)

12. (canceled)

13. The non-transitory computer-readable storage medium of claim 8, wherein the object link comprises at least one of a hidden directory in the file system or one or more sub-directories.

14. The non-transitory computer-readable storage medium of claim 8, wherein the object is the file and the operations further comprise:
receiving a request for a link count for the file; and
providing the link count value.

15. A system comprising:
a memory; and
a processing device coupled to the memory to:
receive a request to access an object in a file system, the request comprising an identifier of the object, wherein the object is a file or a directory;
identify, in view of the identifier of the object, an object link, wherein the object link is a relative symbolic link to the directory; and
access the object using the object link.

16. The system of claim 15, wherein the object is the file and the processing device is further to:
create a file handle for the file;
create the hard link that corresponds to the file handle; and
store the hard link in a hidden directory in the file system.

17. The system of claim 15, wherein the object is the directory and the processing device is further to:
create a directory handle for the directory;
create the relative symbolic link that corresponds to the directory handle; and
store the relative symbolic link in a hidden directory in the file system.

18. (canceled)

19. (canceled)

20. The system of claim 15, wherein the object is the file and the processing device is further to:
receive a request for a link count for the file; and
provide the link count value.
